(19) United States
(12) Patent Application Publication
(10) Pub. No.: US 2018/0045536 A1
(43) Pub. Date: Feb. 15, 2018

(54) On-Line Calibration Testing During The Operation Of An Autonomous Vehicle

(71) Applicant: KUKA Roboter GmbH, Augsburg (DE)

(72) Inventors: Rainer Kümmerle, Munchen (DE); Daniel Meyer-Delius, Munchen (DE); Patrick Pfaff, Augsburg (DE)

(21) Appl. No.: 15/559,569

(22) PCT Filed: Mar. 18, 2016
(86) PCT No.: PCT/EP2016/000486

§ 371 Date: Sep. 19, 2017

(30) Foreign Application Priority Data
Mar. 20, 2015 (DE) 10 2015 205 088.2

(51) Int. Cl. G01C 25/00; G01S 17/08; G05D 1/02

(52) U.S. Cl. CPC G01C 25/00; G05D 1/024; G01S 17/08; G05D 1/0272; G01C 22/00

(57) ABSTRACT

A vehicle and a method for determining a calibration parameter of a vehicle, in particular, of a driverless transport vehicle. The vehicle includes a controller and first and second sensors. Structures proximate the vehicle are detected by the first and second sensors, and the controller determines whether the structures detected by the respective sensors at least partly match. A relative position of the first sensor with respect to the second sensor is calculated based on detected matching structures, and a calibration parameter is determined using the calculated relative position.

### CROSS-REFERENCE

This application is a national phase application under 35 U.S.C. §371 of International Patent Application No. PCT/EP2016/000486, filed Mar. 18, 2016 (pending), which claims the benefit of German Patent Application No. DE 10 2015 205 088.2 filed Mar. 20, 2015, the disclosures of which are incorporated by reference herein in their entirety.

### TECHNICAL FIELD

The present invention relates to a method for determining a calibration parameter of a vehicle, and, in particular, to monitoring an existing calibration using the determined calibration parameter. Furthermore, the present invention relates to a corresponding vehicle, and in particular to a corresponding driverless transport vehicle.

### BACKGROUND

In modern production plants, driverless transport systems are often used to transport material or workpieces from one station to the next. In another example, driverless transport systems may also be used to move manipulators or industrial robots in a production shop. In general, driverless transport systems are conveyor systems which comprise at least one driverless transport vehicle. A driverless transport system may, for example, comprise a robot vehicle which is movable multi-directionally and, in particular, omni-directionally. To this end, such vehicles may, for example, comprise omni-directional wheels which thus enable a high degree of mobility. The coordinate point of origin of such omni-directionally mobile vehicles is usually determined at the center of rotation of the vehicle, but may also be chosen freely as a function of the kinematics.

Driverless transport vehicles are distinguished by the fact that they are guided automatically, i.e. for example, by means of an internal vehicle control device. The movement, i.e. the movement direction and movement speed, are thus controlled by the program. In order for the driverless transport systems to be independently mobile, they are often equipped with facilities for location determination and position detection.

Calibration of autonomous vehicles is understood to mean, among other things, the determination of the installation position of the sensors used for navigation, relative to the coordinate point of origin of the vehicle used. Furthermore, a possible restriction of the field of detection of the sensors may be derived by means of a calibration, as a result of which, for example, the sensors are prevented from detecting the vehicle itself and generating corresponding false collision warnings.

Various methods are known for determining the calibration. In the case of an external measurement, the positions of the sensors attached to the vehicle are measured manually using highly precise measuring devices. However, this method is very time-consuming, expensive and requires the said additional measuring devices.

Furthermore, it is not possible to check the calibration in the operating mode of the driverless transport system.

In another method, the calibration is performed by moving the vehicle and comparing the measurements expected from the movement and the sensor position with the actual movement of the vehicle. Such methods are known, for example, from the scientific article “Automatic Calibration of Multiple Coplanar Systems” by J. Brookshire and S. Teller, which was published in 2011 in “Robotics: Science and Systems”. In this method, the surrounding area is detected during a movement of the vehicle by means of a laser scanner, and the corresponding distance measurements are used to determine the laser scanner's own movement by means of a so-called scan-matching method or scan-matching process.

It is therefore an object of the present invention to provide a method with which calibration of an autonomous vehicle may be carried out with high precision. It is also an object of the present invention to provide a method by which an existing calibration may be efficiently checked.

These and other objects, which will become apparent upon reading the following description.

### SUMMARY

The present invention relates to a method for determining a calibration parameter of a vehicle, and in particular of a driverless transport vehicle. The driverless transport vehicle may be used, for example, in a driverless transport system. For this purpose, the vehicle has at least a first and a second sensor. In this way, the calibration parameter allows determination of a position of at least one of the sensors relative to a coordinate point of origin of the vehicle.

The inventive method comprises the detection of structures by means of the at least two sensors. Preferably, structures are detected in the surrounding area of the vehicle or else in the room in which the vehicle is located.

Thus, for example, objects in the surrounding area of the vehicle are detected, as are also boundaries to the surrounding area, for example walls. In a further step, it is determined whether the structures detected by the two sensors at least partly match. Thus, it is checked whether structures which have been detected by means of the first sensor at least partly match the structures which have been detected by the second sensor. It is thus indirectly checked whether the fields of detection of the two sensors at least partly match or overlap.

Furthermore, the method comprises the calculation of a relative position of at least the first sensor with respect to the second sensor, wherein this calculation preferably takes place after the step of determining whether the detected structures at least partly match. This calculation is based on the detected matching structures. It is thus calculated where the first sensor is located with respect to the second sensor, or where the second sensor is located with respect to the first sensor. At least the structures detected by the two sensors for which a match was determined are used for this calculation. Thereafter, the calibration parameter is determined using at least the calculated relative position of the first sensor with respect to the second sensor.

By means of the inventive method, an independent determination is made as to whether the fields of detection of the two sensors at least partly overlap. Thus, if it is determined that the sensors, for example, at least partially detect the same parts of the surrounding area, then the relative position between the two sensors is directly determined.

This measurement flows into the calibration and thus improves the estimation or determination of the calibration parameters. Thus, the determination of the installation position of sensors which are also used for navigation of the driverless transport vehicle, is fine-tuned. The use of the relative transformation between the sensors allows the desired transformation of the sensor positions to the coordinate point of origin (for example, the center of rotation) of the vehicle, to be stabilized, since the accuracy of determination of the calibration parameter is increased between the two sensors.

Preferably, the inventive method further comprises the detection of a movement of the vehicle. Preferably, this detection is based on a movement of the vehicle, i.e. on odometry, i.e. based on data from the propulsion system of the vehicle. Preferably, the at least one and second sensors are not used for the detection of the movement of the vehicle, so that the detection of the movement of the vehicle based on odometry is preferably not performed using the at least one and second sensors. Furthermore, the determination of the calibration parameter is preferably also carried out using the detected movement of the vehicle. For example, movement of the vehicle is determined from the odometry of the vehicle, and this measurement is used for the calibration of the vehicle. The efficiency and accuracy of a so-called scan-matching method is thereby increased. Preferably, such a scan-matching process is carried out immediately after the detection of the surrounding area data by means of the sensors and more preferably immediately after detection of vehicle movement.

Preferably, the inventive method further comprises the calculation of a movement of the vehicle, wherein this calculation is based on the detected structures. The sensors thus detect the surrounding area during movement of the vehicle and allow the sensors' own movement, or ultimately that of the vehicle, to be determined. Preferably, the determination of the calibration parameter is also carried out using this movement of the vehicle, and is calculated based on the detected structures. Thus, by means of a so-called scan-matching process, an estimation or determination for the relative transformation between the sensors may be performed efficiently, which in turn permits an accurate determination of the calibration parameter. Preferably, based on the thus detected sensors' own movement, a transformation may be calculated from the sensor to the coordinate point of origin of the vehicle or, further preferably, to the odometry center of the vehicle.

Preferably, the determination of the calibration parameter is also carried out using the structures detected by the at least two sensors. Thus, no external measuring devices are necessary with the inventive method, as the sensors used by the vehicle or by the driverless vehicle for navigation are advantageously used instead. The calibration parameter may thus be determined, for example, by correlating the corresponding relations of the sensors, the structures, the vehicle center point, the rotational point of the vehicle and/or the coordinate point of origin of the vehicle, and determining corresponding angles and/or distances using, for example, trigonometric calculations. To this end, for example, a kinematic chain may be established consisting of the vehicle position (based, for example, on odometry) and the sensor position (based, for example, on sensor measurements) at two different instants t1 and t2. In this way, the vehicle position is preferably detected independently of the sensor position.

Preferably, the at least two sensors are configured to perform a distance measurement to a surrounding area of the vehicle. The at least two sensors may preferably comprise laser scanners, stereo cameras and/or time-of-flight cameras, all of which preferably allow the measurement of distance measurements. Further preferably, the sensing of the structures includes performing a distance measurement to a surrounding area of the vehicle. By means of the at least two sensors, distance measurements are thus carried out in order to detect or recognize objects in the room. Since these sensors are preferably also used for the operation of the vehicle, for example for the navigation of the vehicle, the calibration parameter may also be performed efficiently during the operation of the vehicle, with the sensors already present, so that no additional sensors are necessary.

Preferably, the detection of structures is performed when the vehicle is stationary. Thus, aliasing effects may be avoided in determining whether the detected structures at least partly match.

Alternatively, the detection of structures may also be performed at a reduced speed in order to at least reduce such aliasing effects.

Preferably, the transformation between the installation position of a sensor and the coordinate point of origin of the vehicle allows the structures detected by the sensor to be linked with a movement of the vehicle or an orientation of the vehicle. A particular advantage of the inventive method is that the initial installation position of a sensor (relative to the coordinate system of the vehicle) need not be known; it may be determined completely and automatically by means of the inventive method. The calibration parameter preferably comprises further parameters, such as, for example, a limitation of the field of detection of a sensor, or a masking of the sensor. Thus, it may advantageously be ensured that the detected structures do not originate from the vehicle itself.

Preferably, a position and an orientation of the vehicle may be determined by means of at least one of the at least two sensors and the calibration parameter. Thus, the calibration parameter comprises, for example, information relating to the positions of the sensors, which may be used for determining the position and orientation of the vehicle.

Preferably, the determination as to whether the detected structures at least partially match includes determining whether the fields of detection of the at least two sensors overlap. To this end, it may, for example, be checked whether the structures detected in a partial angular range of a first sensor are also detected by a second sensor. This partial angular range may preferably be at least 10 degrees, more preferably at least 20 degrees, and further preferably at least 30 degrees.

The structures detected within such a partial angular range preferably do not have to match 100%, but more preferably at least 90%, or further preferably at least 80%. This makes it possible to check effectively and quickly whether the two sensors at least partially detect the same parts of the surrounding area. Preferably, a method of least squares is used for the determination of the calibration parameter, i.e. the searched parameters are determined by means over several time steps. Since both the odometry and the scan-matching process may be affected by noise, the precision of the method, and consequently the accuracy of the calibration parameter, are further improved.

Preferably, a sensor measurement is rejected when the result of the scan-matching process deviates widely from an expected result. The expected result may, for example, be based on an existing (previous) calibration.

Preferably, the vehicle has more than two sensors. To carry out the inventive method, pairs of sensors are set up, and the inventive method is preferably carried out for all pairs of sensors.

Preferably, during a commissioning phase or a calibration run, a calibration parameter is determined or updated or fine-tuned until a previously determined quality of the calibration has been achieved. The calibration is determined continuously until a predetermined criterion for aborting the calibration has been reached. Preferably, the criterion may comprise a remaining residual uncertainty in the parameter determination, a time specification or a number of determinations of the calibration parameter to be carried out. Preferably, even after the calibration has been completed, the calibration parameter is further determined, for example at predetermined time intervals, for monitoring or checking the calibration.

Preferably, the determined calibration parameter may be used to monitor or check an existing calibration of the vehicle.

Consequently, the determined calibration parameter is preferably compared in a further step with at least one existing calibration parameter. This existing calibration parameter will have preferably been prepared in a preceding calibration step and is used in the ongoing operation of the vehicle.

During such monitoring, the vehicle may operate normally, since the monitoring is carried out in the background and does not have to intervene actively in the control of the vehicle. For the comparison of the ascertained calibration parameters with the existing calibration, a so-called Kullback-Leibler divergence, a so-called Mahanalobis distance measurement, and/or comparable techniques may be used, for example. If a deviation is present, an operator or service technician may be informed automatically and, if necessary, the vehicle may be stopped if the deviation exceeds a corresponding predefined limit value. Further preferably, the monitoring may also be based on the distances between the sensor measurements during movement of the vehicle. The present invention thus also allows detection of violations of assumptions of a previous calibration method. Thus, it may be detected, for example, that the sensors are not horizontal, the sensors are not installed at the same level, and/or the field of detection of one or more sensors comprises the vehicle itself.

Furthermore, the present invention relates to a method for monitoring an existing calibration parameter of a vehicle, and, in particular, to a driverless transport vehicle, wherein the vehicle comprises at least first and second sensors, and wherein the existing calibration parameter is a determination of a position of at least one of the sensors relative to a vehicle coordinate point of origin of the vehicle. The existing calibration parameter will have been preferably determined during a previous calibration step, and is preferably also used during operation of the vehicle to control the latter. Accordingly, the method for monitoring is preferably applied in the vehicle's operating mode to check a previous calibration.

Accordingly, the method includes detecting a movement of the vehicle based on odometry, detecting structures by means of the at least two sensors at a first instant t1, and detecting structures by means of the at least two sensors at a second instant t2. Preferably the vehicle is in motion and the first instant t1 is different from the second instant t2. Thus, during the detection of the structures at the two instants t1 and t2, the vehicle is preferably at different positions in the room.

Furthermore, according to the inventive method for monitoring, a check is made as to whether a difference between the detected structures at the first instant t1 and the detected structures at the instant t2 corresponds to the detected movement of the vehicle. It is thus possible to determine efficiently and directly whether, for example (based on the existing calibration parameter), a field of detection of a sensor includes the vehicle itself, which may mean a violation of an assumption made during the preceding calibration step. Thus, such assumptions may be directly checked during the operation of the vehicle. If, for example, based on odometry, a vehicle translational movement of one meter between t1 and t2 has been determined, structures in the direction of movement of the vehicle at instant t2 must be detected by sensors as being one meter closer than at instant t1. Otherwise, a faulty calibration parameter or a fault in the odometry may be present.

Preferably, so-called occupancy mapping may be performed to check an existing calibration, preferably using the determined and/or existing calibration parameter. To this end, local maps are constructed based on the odometry, the sensor data and/or the calibration parameter(s), which are preferably provided accordingly, wherein the entropy of the maps produced in this way provide a criterion for the validity of the calibration parameters. The measurements of the sensors are entered into a grid, preferably a 2D grid. For each cell in the grid, it is then analyzed how often a measurement of a sensor passes through or ends in this cell. In the event of inconsistencies in the occupancy probability, preferably during movement of the vehicle, an incorrect calibration may subsequently be deduced, for example. This independent verification of the quality of the calibration may preferably be carried out at the same time for the repeated use of the calibration parameter in order, for example, to detect violations of assumptions of the calibration method. Consequently, errors in the odometry may be concluded and an appropriate operator or service technician may be automatically informed.

Furthermore, the present invention relates to a vehicle and, in particular, to a driverless transport vehicle which has at least a first and a second sensor. The vehicle also comprises a controller which is adapted to carry out an inventive method for determining a calibration parameter of the vehicle.

Preferably, the at least two sensors are configured to perform a distance measurement to a surrounding area of the vehicle. Furthermore, preferably, a field of detection of the first sensor coincides at least partially with a field of detection of the second sensor. Preferably, the at least two sensors comprise laser scanners, stereo cameras and/or time-of-flight cameras. This list is not exhaustive; in general, all sensors which are suitable for determining the structures of the surrounding area of the vehicle may be used.

Preferably, the inventive vehicle further comprises at least one odometry sensor with which a movement of the vehicle, based on odometry, may be detected. Persons skilled in the art will understand that various aspects of the methods described above and the vehicle described above may be combined, and that the various aspects of the disclosure are not necessarily mutually exclusive.

### BRIEF DESCRIPTION OF THE DRAWINGS

The present invention is described in more detail below with reference to the appended figures:

FIGS. 1 and 2 show schematically the sequence of a scan-matching process in the sense of the present invention, and

FIG. 3 shows schematically the sequence of the inventive method.

### DETAILED DESCRIPTION

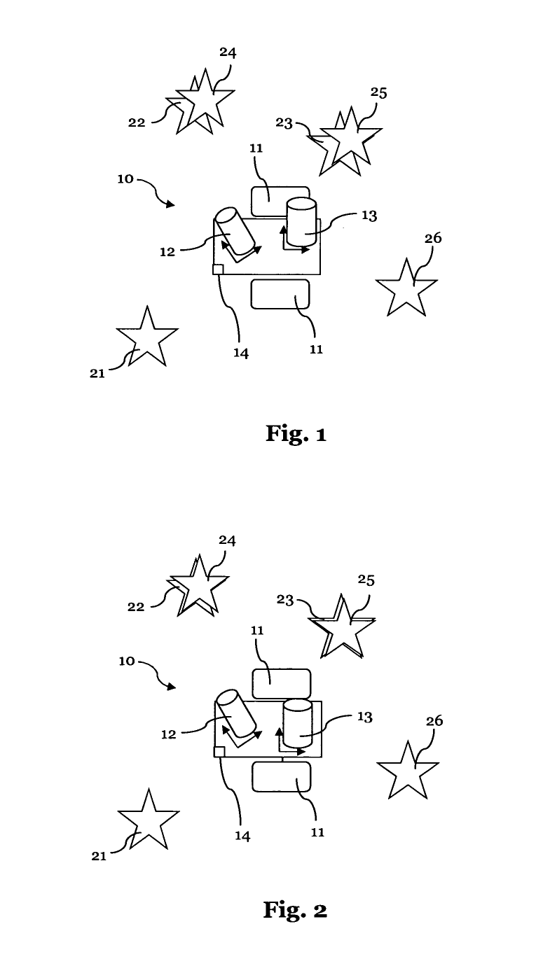

FIG. 1 schematically shows a vehicle 10 which is equipped with a first sensor 12 and a second sensor 13. As may be seen in FIG. 1, the two sensors 12, 13 are installed at different positions on the vehicle 10 and also have different coordinate systems. Furthermore, the vehicle 10 comprises two wheels 11 which are equipped with corresponding odometry sensors in order to be able to determine the vehicle's own movement based on odometry. This determination of the vehicle movement as well as the regulation of the sensors 12, 13 is carried out by a controller 14. This controller 14 is arranged to carry out the inventive method for determining a calibration parameter of the vehicle 10.

By means of the first sensor 12, for example, the objects or structures 21, 22, 23 are detected in the surrounding area of the vehicle 10, while the structures or objects 24, 25, 26 are detected in the surrounding area of the vehicle 10 by means of the second sensor 13, for example. By means of the inventive method, it is recognized that the features 22 and 24 as well as 23 and 25 match one another.

As shown in FIG. 2, the execution of the scan-matching process allows estimation or determination for the relative transformation between the sensors 12, 13. Here, the objects 24, 25, 26 recorded or detected by means of the second sensor 13 have been accordingly shifted. Accordingly, a relative position of the second sensor 13 with respect to the first sensor 12 was also calculated. Based on this calculated relative position between the two sensors 12, 13, the calibration of the vehicle was updated, thereby fine-tuning the installation position of the sensor 13. As may be seen in comparison with FIG. 1, a new calibration parameter was used in FIG. 2, and thus the position of the second sensor 13 stored in the controller 14 is updated with respect to the coordinate system of the vehicle.

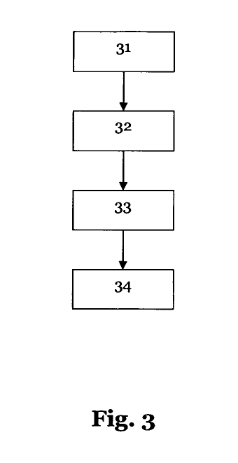

FIG. 3 schematically shows the sequence of the inventive method for determining a calibration parameter of a vehicle. The vehicle has at least a first and a second sensor, such as the sensors 12, 13 of the vehicle 10 from FIGS. 1 and 2. In step 31, at least two sensors are used to detect structures in the surrounding area of the vehicle. For example, the structures 21, 22, 23, 24, 25, 26 of FIGS. 1 and 2 may be detected by the at least two sensors.

In step 32, it is determined whether the detected structures at least partly match. To this end, it is possible, for example, to check whether there is an overlap of the fields of detection of the at least two sensors. For this purpose, an angular range of 30 degrees may be considered, and following adjustment of the sensors, the corresponding covariance may be considered. The consideration of the covariance against the background of a predetermined threshold value may thus be used to determine whether or not there is an overlap of the fields of detection of the at least two sensors. In particular, by considering the covariance, it may be ensured that a match between the two sensors provides a stable result. For example, determining a single line as a registered structure may lead to a great uncertainty along this line. The detection and filtering of this unstable match is thus particularly advantageous for the determination of a reliable calibration parameter. To this end, it may be checked, for example, whether the structures detected in an angular range of the first sensor are also detected by means of the second sensor, i.e. whether a corresponding angular range of the fields of detection is present. Referring to the illustration in FIGS. 1 and 2, it was determined, for example, that an angular range of the first sensor 12, in which angular range the objects or structures 22 and 23 are located, matches an angular range of the second sensor 13, in which angular range the objects or structures 24 and 25 are located.

In step 33, a relative position of at least the first sensor with respect to the second sensor is then calculated, which is based on the detected matching structures. To this end, for example, trigonometric methods may be used.

In step 34, the calibration parameter is determined using at least the calculated relative position of the at least two sensors. For example, the movement of the vehicle center point, which was detected, for example, by means of odometry, may also be included. In order to reduce errors by possibly occurring noise, a spring-mass system may be used.

In this case, the movement of the vehicle center point and the movement of at least one sensor is considered and a corresponding kinematic chain is formed. After multiplying the corresponding motion matrices, a deviation of the result from the expected identity matrix may be used to suppress noise, for example.

Preferably, the vehicle interrupts or slows its travel around the structures by means of the sensors. By running one or more curves, the determination of the calibration parameter may preferably be further supported. Thus, the calibration parameter may be determined by considering a corresponding vehicle movement, which is determined, for example, by means of odometry, and a sensor movement, which is determined as a function of the detected structures.

In a further preferred exemplary embodiment, the validity of the calibration may be monitored simultaneously to determine a calibration parameter. For this purpose, local maps, which are divided into grid cells, are constructed by means of odometry of the vehicle, laser measurements and a current calibration parameter. For each cell in the grid it is analyzed how often a laser beam of the laser measurement passed this grid cell, and how often a laser measurement ended in this grid cell. Thus, it is checked for which cells in the grid a laser measurement was performed. If, for example, two laser scanners are installed at different heights in the vehicle, an object may be detected by one scanner, for example, while the second scanner does not detect this object but measures beyond it. This leads to inconsistencies in the occupancy probability of the corresponding grid cell, wherein it may be determined that the laser scanners have been installed at different heights.

Likewise, a tilting of a scanner may be recognized in this way. Furthermore, it may advantageously be determined by means of this method whether, for example, a laser scanner detects the vehicle itself, i.e. the masking of the laser data is insufficient. Furthermore, artifacts in the grid cells may also be rejected, for example, by contamination of a sensor.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE NUMERALS

10 Vehicle
11Tires with odometry sensor
12, 13 Sensors
14 Controller
21, 22, 23, 24, 25, 26 Objects/structures
31, 32, 33, 34 Steps of the method

1-14. (canceled)

15. A method for determining a calibration parameter of a vehicle having at least first and second sensors, wherein the calibration parameter is a determination of a position of at least one of the sensors relative to a coordinate point of origin of the vehicle, the method comprising:
detecting structures proximate the vehicle with the at least first and second sensors;
determining whether the structures detected by the respective sensors at least partly match;
calculating a relative position of at least the first sensor with respect to the second sensor based on the matching detected structures; and
determining the calibration parameter by using at least the calculated relative position of the first sensor with respect to the second sensor.

16. The method of claim 15, wherein the vehicle is a driverless transport vehicle.

17. The method of claim 15, further comprising:
detecting a movement of the vehicle;
wherein determining the calibration parameter further comprises using the detected movement of the vehicle.

18. The method of claim 17, wherein the detection of the movement of the vehicle is performed by odometry.

19. The method of claim 15, further comprising:
calculating a movement of the vehicle based on the detected structures;
wherein determining the calibration parameter further comprises using the calculated movement of the vehicle.

20. The method of claim 15, wherein determining the calibration parameter further comprises using the detected structures.

21. The method of claim 15, wherein:
the at least first and second sensors are configured to perform a measurement of distance to a surrounding area of the vehicle; and
detecting the structures comprises performing a distance measurement to a surrounding area of the vehicle.

22. The method of claim 21, wherein the at least first and second sensors comprise at least one of laser scanners, stereo cameras, or time-of-flight cameras.

23. The method of claim 15, wherein detecting the structures is performed while the vehicle is stationary.

24. The method of claim 15, further comprising determining a position and an orientation of the vehicle using the calibration parameter and at least one of the first or second sensors.

25. The method of claim 15, wherein determining whether the detected structures at least partially match comprises determining whether fields of detection of the at least first and second sensors overlap.

26. The method of claim 15, further comprising comparing the determined calibration parameter with at least one existing calibration parameter.

27. A method for monitoring an existing calibration parameter of a vehicle, wherein the vehicle includes at least first and second sensors, and wherein the existing calibration parameter determines a position of at least one of the sensors relative to a coordinate point of origin of the vehicle, the method comprising:
detecting a movement of the vehicle based on odometry;
detecting structures using the at least first and second sensors at a first instant in time;
detecting structures using the at least first and second sensors at a second instant in time;
checking whether a difference between the detected structures at the first instant in time and the detected structures at the second instant in time corresponds to the detected movement of the vehicle.

28. The method of claim 27, wherein the vehicle is a driverless transport vehicle.

29. A vehicle, comprising:
at least one first sensor and at least one second sensor; and
a controller configured to perform the method of claim 15.

30. The vehicle of claim 29, wherein the vehicle is a driverless transport vehicle.

31. The vehicle of claim 29, wherein:
the at least first and second sensors are configured to perform a measurement of distance to a surrounding area of the vehicle; and
a field of detection of the first sensor at least partly matches a field of detection of the second sensor.

32. The vehicle of claim 29, wherein the at least first and second sensors comprise at least one of laser scanners, stereo cameras, or time-of-flight cameras.

33. The vehicle of claim 29, further comprising at least one odometry sensor configured to detect a movement of the vehicle based on odometry.
